(19) United States
(12) Patent Application Publication
(10) Pub. No.: US 2009/0311577 A1
(43) Pub. Date: Dec. 17, 2009

(54) CORROSION-RESISTANT MATERIAL AND MANUFACTURING METHOD OF THE SAME

(75) Inventors: Mineo WASHIMA, Tsuchiura-shi (JP); Takaaki SASAOKA, Tsuchiura-shi (JP)

Correspondence Address: Fleit Gibbons Gutman Bongini & Bianco PL, 21355 EAST DIXIE HIGHWAY, SUITE 115, MIAMI, FL, 33180, US

(73) Assignee: HITACHI CABLE, LTD., Tokyo (JP)

(21) Appl. No.: 12/468,524

(22) Filed: May 19, 2009

(30) Foreign Application Priority Data
Jun. 12, 2008 (JP) 2008-153792
Jan. 13, 2009 (JP) 2009-4636

(51) Int. Cl. H01M 2/16; H01M 8/00; H01M 2/00; B32B 15/04

(52) U.S. Cl. 429/34; 427/115; 428/457; 428/632

(57) ABSTRACT

A corrosion-resistant material of the present invention includes a substrate with at least one surface made of aluminum or an aluminum alloy; a corrosion-resistant coating layer for coating the one surface of the substrate; and a corrosion-resistant sealing material made of hydrated aluminum oxide generated in fine pores, being a defect that occurs in the corrosion-resistant coating layer, to thereby seal the fine pores.

### BACKGROUND

1. Technical Field

The present invention relates to a corrosion-resistant material and a manufacturing method of the same, and relates to a separator for a fuel cell and the manufacturing method of the same, and particularly relates to the corrosion-resistant material in a state that one surface of a substrate made of aluminum or an aluminum alloy is coated with a corrosion-resistant coating layer, a manufacturing method of the same, a separator for a fuel cell, and a manufacturing method of the same.

2. Description of Related Art

Although aluminum or an aluminum alloy is used in various fields including a separator for a fuel cell, owing to its light weight and excellent electric characteristics, there is a problem that it is low in corrosion-resistant property.

Therefore, there is a technique capable of improving a corrosion-resistant property by providing a corrosion-resistant layer of a metal thin film on the surface of an aluminum material (for example, see patent document 1). However, sufficient improvement of the corrosion-resistant property is not realized. Therefore, by depositing an anodized film (aluminum oxide film) on the surface of the aluminum by an anodizing method, and further by depositing a coating film of silicon dioxide on the surface of the anodized film, an attempt is made to seal fine pores and cracks (simply called fine pores hereinafter), being a defect of the aluminum oxide (for example, see patent document 2).

### (Patent Document 1)

### Japanese Patent Laid Open Publication No. 2001-266913

### (Patent Document 2)

### Japanese Patent Laid Open Publication No. 2001-172795

However, even if the coating film of silicon dioxide is formed on the surface of the anodized film, each fine pore is hardly sealed up to an innermost part thereof, because the fine pores of the aluminum oxide is sealed from outside. Therefore, sufficient corrosion-resistant property is not realized, and there is a problem that corrosion is advanced by electrolytes and potentials of sulfuric acid, oxalic acid, phosphoric acid, and chromic acid, etc.

Therefore, an object of the present invention is to provide a corrosion-resistant material capable of suppressing an advancement of corrosion by improving the corrosion-resistant property, a manufacturing method of the same, a separator for a fuel cell, and a manufacturing method of the same.

### SUMMARY OF THE INVENTION

Generally, according to a certain aspect of the present invention, there is provided a corrosion-resistant material having a substrate, with at least one surface made of aluminum or aluminum alloy; a corrosion-resistant coating layer for coating the one surface of the substrate; and a corrosion-resistant sealing material made of hydrated aluminum oxide, generated in fine pores, being a defect that occurs in the corrosion-resistant coating layer, to thereby seal the fine pores.

Generally according to a certain aspect of the present invention, there is provided a manufacturing method of a corrosion-resistant material including the steps of: depositing a corrosion-resistant coating layer on at least one surface of a substrate made of aluminum or an aluminum alloy; generating a corrosion-resistant sealing material made of hydrated aluminum oxide in fine pores, being a defect that occurs in the corrosion-resistant coating layer; and sealing the fine pores by the sealing material.

Generally, according to a certain aspect of the present invention, there is provided a separator for a fuel cell having a substrate, with at least one surface made of aluminum or an aluminum alloy; a corrosion-resistant coating layer for coating one surface of the substrate; and a corrosion-resistant sealing material made of hydrated aluminum oxide, generated in fine pores, being a defect that occurs in the corrosion-resistant coating layer, to thereby seal the fine pores.

Generally, according to a certain aspect of the present invention, there is provided a manufacturing method of the separator for the fuel cell including the steps of: depositing a corrosion-resistant coating layer on at least one surface of a substrate made of aluminum or an aluminum alloy; generating a corrosion-resistant sealing material made of hydrated aluminum oxide in fine pores, being a defect that occurs in the corrosion-resistant coating layer; and sealing the fine pores by the sealing material.

Other aspect and an advantage of the present invention will be apparent from the best mode for carrying out the invention and the appended scope of the claims.

According to the present invention, the corrosion-resistant property of the corrosion-resistant material is ensured, because the defect that occurs in the corrosion-resistant coating layer is sealed by the hydrated aluminum oxide having a corrosion-resistant property.

### BRIEF DESCRIPTION OF THE DRAWINGS

FIG. 1 is a sectional view showing a corrosion-resistant material according to an embodiment and an example of the present invention.

FIG. 2 is an expanded detailed sectional view of an essential part showing fine pores, being a defect of a coating layer of the corrosion-resistant material according to the embodiment of the present invention.

FIG. 3 is a detailed sectional view of the essential part showing a state in which an aluminum oxide coating film is formed on the surface of a substrate through the fine pores of the corrosion-resistant material, according to the embodiment and the example 1 of the present invention.

FIG. 4 is a sectional view showing a structure of the corrosion-resistant material according to the embodiment and the example 1 of the present invention.

FIG. 5 is a sectional view showing the structure of the corrosion-resistant material according to an example 2 of the present invention.

FIG. 6 is a detailed sectional view of the essential part showing a state in which the aluminum oxide coating film is formed on the surface of the substrate through the fine pores of the coating layer of the corrosion-resistant material according to the example 2 of the present invention.

FIG. 7 is a detailed sectional view of the essential part showing a state in which the fine pores of the coating layer of the corrosion-resistant material according to the example 2 of the present invention is sealed by a sealing part made of hydrated aluminum oxide.

FIG. 8 is an exploded perspective view showing an outline structure of a solid polymer electrolyte fuel cell according to another embodiment of the present invention.

### DESCRIPTION OF PREFERRED EMBODIMENT OF THE INVENTION

In a first aspect of a corrosion-resistant material of the present invention, the corrosion-resistant material includes: a substrate coated with a corrosion-resistant coating layer; and a sealing part for sealing fine pores, being a defect of a coating layer, wherein at least a contact surface between the substrate and the coating layer is made of aluminum or an aluminum alloy, and the sealing part is made of hydrated aluminum oxide generated in the fine pores.

The hydrated aluminum oxide is formed by anodizing the contact part through the fine pores and boiling aluminum oxide oxidized by anodization in pure water.

The corrosion-resistant coating layer stable to electrolytes and potentials of sulfuric acid, oxalic acid, phosphoric acid, and chromic acid, etc, is used. The hydrated aluminum oxide is also stable to these acids and potentials. Therefore, the corrosion of the contact part made of aluminum or the aluminum alloy can be prevented. In addition, when the fine pores of the coating layer is sealed by the sealing part, there is no necessity for increasing a thickness of the coating layer, and therefore reduction of cost is possible, even when the coating layer is formed by sputtering and other thin film deposition method.

Also, in a second aspect of the corrosion-resistant material of the present invention according to the first aspect, the corrosion-resistant coating layer is made of one kind selected from titanium, titanium nitride, stainless, nickel, chromium, gold, platinum, palladium, rhodium, copper, tin, and silver.

These materials are stable to the electrolytes and potentials of the sulfuric acid, oxalic acid, phosphoric acid, and chromic acid, etc, and also the sealing part of the hydrated aluminum oxide is stable to these electrolytes and potentials. Accordingly, corrosion-resistant property of the corrosion-resistant metal is ensured, and the corrosion-resistant property of the corrosion-resistant material is ensured.

Further, in a third aspect of the corrosion-resistant material of the present invention according to the first aspect, the corrosion-resistant coating layer is made of any one of a nitride of titanium and aluminum, an oxide of titanium and aluminum, and a mixture thereof.

These materials are also stable to the electrolytes and potentials of the sulfuric acid, oxalic acid, phosphoric acid, and chromic acid, etc, and also the sealing part of the hydrated aluminum oxide is stable to these electrolytes and potentials. Accordingly, the corrosion-resistant property of the corrosion-resistant metal is ensured and the corrosion-resistant property of the corrosion-resistant material is ensured.

Preferred embodiments of the present invention will be described hereunder, based on the attached drawings.

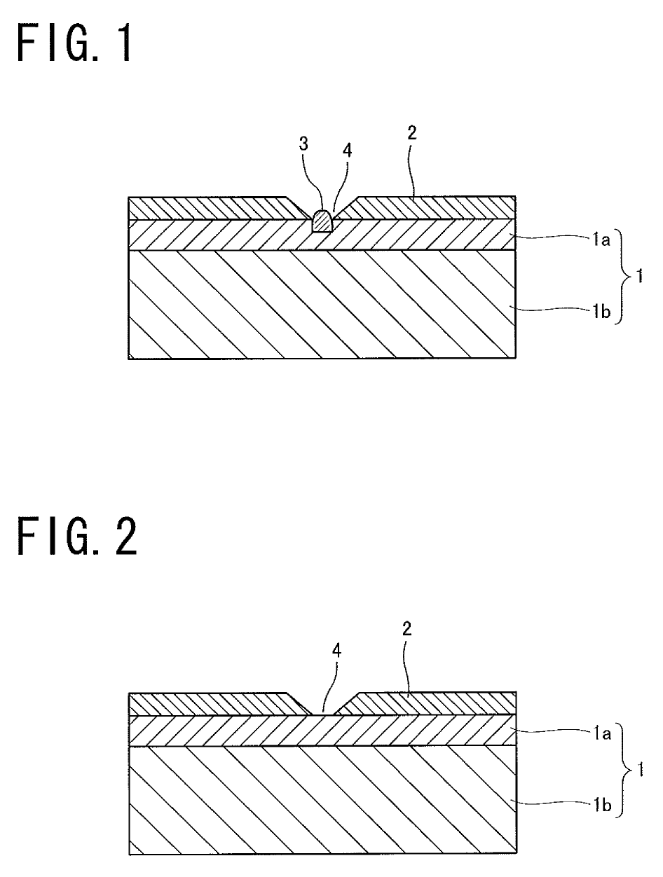

FIG. 1 is a sectional view showing a corrosion-resistant material according to an embodiment of the present invention.

As shown in the figure, the corrosion-resistant material includes a substrate 1, a coating layer 2 made of a thin film, and a sealing part 3. The surface of one surface of the substrate 1 is coated with the coating layer 2, and a fine pore 4, being a defect of the coating layer 2, is sealed by the sealing part 3. The coating layer 2 has about 10 nm to 0.5 nm thickness, and the fine pore 4, being a defect, has 10 nm to 0.5 mm size, which are the same as the thickness of the coating layer in many cases. According to this embodiment, a substrate upper part 1a, namely a contact surface between the substrate and the coating layer 2 is made of aluminum or an aluminum alloy, and a substrate lower part 1b is also made of aluminum or the aluminum alloy. However, by cladding stainless or copper on a lower surface of the substrate upper part 1a, the substrate may be formed in a state that the substrate lower part 1b made of stainless or copper is coated with aluminum or the aluminum alloy (coating material). Also, an entire body of the substrate 1 may be made of aluminum or the aluminum alloy. Note that for example, an alloy of titanium and aluminum can be given as the aluminum alloy.

The coating layer 2 is made of the corrosion-resistant material selected from titanium, titanium nitride, stainless, nickel, chromium, gold, platinum, palladium, rhodium, copper, tin, and silver, or the corrosion-resistant material selected from a nitride of titanium and aluminum, such as TiAlN (titanium aluminum nitride), an oxide of titanium and aluminum such as TiAlO (titanium aluminum oxide), or a mixture thereof such as TiAlON (titanium aluminum oxynitride).

The thickness of the substrate upper part 1a is set to be the thickness of a diameter or more of the fine pore 4, because the fine pore 4 is covered with hydrated aluminum oxide. The thickness of the substrate upper part 1a is set to be the thickness of a diameter or more of the fine pore 4. The reason is that the thickness thicker than the diameter of the fine pore 4 is desirable to prevent generation of an insufficient aluminum, because the hydrated aluminum oxide is formed by supplying aluminum from the substrate upper part itself.

Also, a size of the fine pore 4 becomes approximately the same as the thickness of the coating layer 2 in many cases, and the thickness of the substrate upper part 1a is desirably set thicker than the thickness of the coating layer 2.

The sealing part 3 is made of hydrated aluminum oxide, being a corrosion-resistant metal. The corrosion-resistant material and hydrated aluminum oxide are stable to electrolytes and potentials of sulfuric acid, oxalic acid, phosphoric acid, and chromic acid, etc, and have a corrosion-resistant property. Therefore, the corrosion-resistant property of the substrate upper part (contact part) is ensured by the coating layer 2 and the sealing part 3.

The coating layer 2 is formed on the surface of the substrate 1 by a sputtering method, a vapor deposition method, or by cladding. When the coating layer 2 is deposited on the surface of the substrate 1, a method selected from an electronic beam vapor deposition method, a PVD (Physical Vapor Deposition) method, and an ion beam vapor deposition method, is used.

The PVD method is one of vapor deposition methods for depositing a thin film on a surface of a substance, and is a method for depositing a thin film on the surface of a target substance in a vapor phase by a physical technique, and the CVD method is a method of depositing the thin film on the surface of a target substance (a physical vapor growth method or a physical vapor deposition method) by a chemical adsorbing reaction. Also, the sputtering method is a method of beating out atoms from a metal, being a raw material, to deposit it on a surface to be treated.

The CVD method has a characteristic that a broad treatment range can be obtained, because a gas material (a source gas) penetrates into a film compared with a normal thin film deposition method such as sputtering suitable for forming a planar thin film. Thus, even a three-dimensional complicated shape can also be coated. Also, the CVD method has a characteristic that the coating of a constant film thickness is achieved, thus realizing a broad utility. However, the CVD method is not suitable as a coating method for depositing pure titanium. Therefore, when the coating layer 2 made of pure titanium is formed, the sputtering method is used.

When a titanium-based coating layer 2 made of not pure titanium is formed, the coating layer 2 is formed by raw materials of nitride and carbide using the CVD method. In this case, the coating layer 2 is formed by mixing the nitride, carbide and aluminum and supplying this mixture onto the substrate upper part 1a in a state of a mixture of aluminum and nitrided carbide.

When titanium nitride is used as a coating material (raw material) for depositing the coating layer 2, to form the coating layer 2 made of titanium nitride or the coating layer 2 in a state of the mixture of titanium nitride and aluminum, on the surface of the substrate upper part 1a, a surface hardness of the coating layer 2 is increased, and the corrosion-resistant property is also improved.

The sealing part 3 is formed by the step of depositing an aluminum oxide coating film on the surface of the substrate upper part 1a under the fine pore 4 through the fine pore 4 of the coating layer 2, and the step of boiling the aluminum oxide coating film in pure water to thereby generate hydrated aluminum oxide (hydrate of aluminum oxide).

As shown in FIG. 1, the generated hydrated aluminum oxide swells toward the coating layer 2 from the substrate upper part 1a in the fine pore 4, and serves as the sealing part 3 to seal the fine pore 4 of the coating layer 2. A mechanism of sealing the fine pore 4 by swelling of the hydrated aluminum oxide is that aluminum oxide is changed into hydrated gelatin when aluminum oxide is turned into the hydrated aluminum oxide by boehmite-treatment, and the fine pore 4 is thereby sealed by a swelled volume.

As described above, the hydrated aluminum oxide is also stable to the electrolytes and potentials of sulfuric acid, oxalic acid, phosphoric acid, and chromic acid, etc, and has the corrosion-resistant property. Therefore the corrosion-resistant property of the corrosion-resistant material can be ensured.

Note that in the aforementioned embodiment, the coating layer 2 is deposited on one of the surfaces of the substrate. However, when not only one of the surfaces but also the other surface of the substrate is set as a surface to be treated, the substrate lower part becomes a coating target in some cases, together with the substrate upper part.

Next, a manufacturing method of a corrosion-resistant material according to this embodiment will be described.

First, as shown in FIG. 2, the substrate 1 is made of aluminum or an aluminum alloy of prescribed thickness. Next, the coating layer 2 made of Ti (titanium), being a corrosion-resistant metal, is formed. The corrosion-resistant metal is selected by its purpose of use and cost, and a deposition method is selected from the sputtering, CVD, PVD, and ion beam deposition. When the coating layer 2 is formed by sputtering and vapor deposition, it is not possible to prevent a defect, namely a generation of the fine pore 4 caused by foreign matters previously adhered to the surface of the substrate 1 or foreign matters generated during process. Thus, the fine pore 4 as shown in FIG. 2 is sometimes generated. Although it is difficult to specify a density of the defect of the coating layer 2 which is exposed in nano-order such as a density of the fine pore 4, an area ratio of the density is 1/10,000 or less and the density of the fine pore 4 is about 100/cm².

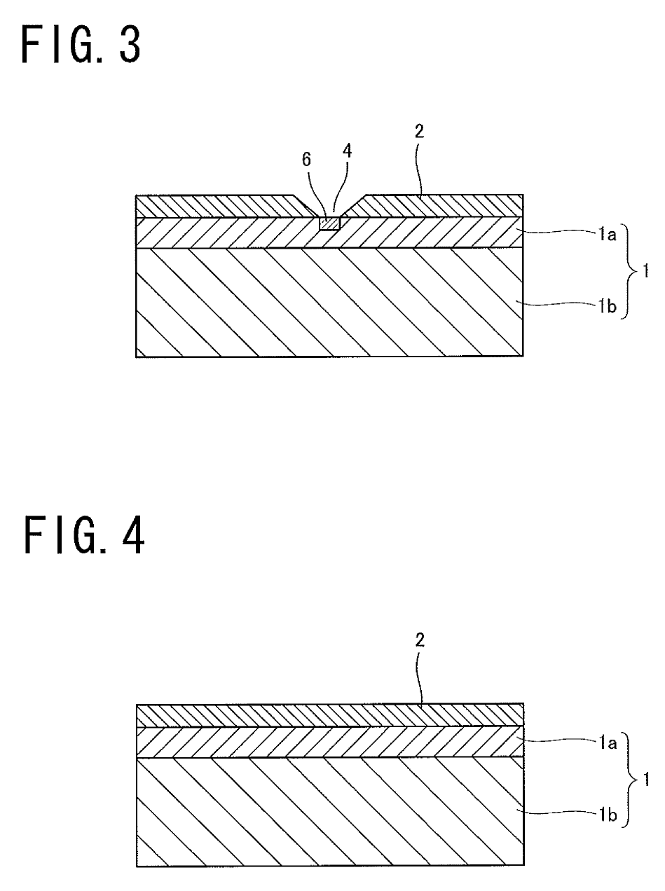

Next, the corrosion-resistant material is treated by a publicly-known anodizing method, and as shown in FIG. 3, an aluminum oxide coating film 6 is deposited on the surface of aluminum of the substrate upper part 1a which is exposed under the fine pore 4. A surface state of the aluminum oxide coating film 6 is sometimes flat and is sometimes opened into a honeycomb shape, depending on the kind, concentration, voltage, and temperature of the electrolyte, which are conditions of anodization. In any case, hydrated aluminum oxide-depositing treatment called a bore-sealing treatment by boiling as will be described later is necessary, and the fine pore 4, being the defect, must be sealed by swelling of hydrated aluminum oxide, so that a finer substrate upper part 1a can be formed. An example of the embodiment shown in FIG. 3 shows a case that the surface is flat.

A solution obtained by dissolving a soluble electrolyte in the pure water is used as an electrolyte solution used in anodization. The soluble electrolyte is suitably selected from the sulfuric acid, oxalic acid, chromic acid, phosphoric acid, sulfamic acid, and benzenesulfonic acid.

A content concentration of the soluble electrolyte is set to be 0.01 to 90 wt % in a standard state (0° C. at 1 atmosphere) when the soluble electrolyte is set in a solid state, and is set to be 0.01 to 85 vol % in a standard state (0° C. at 1 atmosphere) when the soluble electrolyte is set in a liquid state.

Also, distilled water, ion-exchange water, or concentrated water by RO (reverse osmosis membrane) is used as the pure water. In this case, in order to improve the characteristics of the aluminum oxide coating film 6, impurities such as chlorine is sufficiently removed.

When the coating layer 2 is formed by a titanium compound such as titanium nitride, the titanium compound is sometimes eluted, during anodizing aluminum of the substrate upper part 1a under the fine pore 4. In order to prevent such a state, pre-treatment is required in advance. The pre-treatment of preventing an elution of the titanium compound is a treatment in which the titanium compound of nitride and/or carbide are heated in an atmosphere of oxygen, to thereby accelerate oxidation and improve the corrosion-resistant property. Conditions at the time of the pre-treatment are suitably set as follows. The temperature is set at about 200° C. to 600° C., and time is set at about 1 minute to about 1 hours.

An electrolytic bath (anodizing bath) made of stainless steel or hard glass is used. A liquid level of the electrolyte solution (an anodized solution) is determined so as to be suitable for anodization, wherein the substrate 1 after forming the coating layer 2 is set as an anode, and a stainless steel or an aluminum plate or a metal plate coated with platinum selected depending on conditions is set as a cathode. In this case, both electrodes are disposed, with a certain specific inter-electrode distance provided between both electrodes. Although either one of a DC-current power source and an AC-current power source may be set as a power source for anodization, the DC-current power source is used here.

An inter-electrode distance between the anode and the cathode is suitably determined within a range from 0.1 cm to 100 cm normally, and a current density during anodization is determined to be normally 0.0001 to 10 A/cm², and preferably determined to be 0.0005 to 1 A/cm². Also, a voltage for anodization is determined to be 0.1 to 1000V normally, and preferably determined to be 0.1 to 700V. Also, a liquid temperature of the electrolyte solution is set to be 0 to 100° C., and preferably set to be 10 to 95° C.

Under such conditions, a positive (plus) terminal of the DC current power source device is connected to the substrate 1 of the corrosion-resistant material, and a negative (minus) terminal is connected to the metal plate (cathode plate) used as the cathode, and a DC current is supplied between both electrodes of the anode and the cathode in the electrolyte solution.

By energizing, aluminum of the substrate upper part 1a under the fine pore 4 of the corrosion-resistant material, being the anode, is oxidized, and the aluminum oxide coating film 6 is formed as shown in FIG. 3. Also, the titanium of the coating layer 2 is weakly anodized, and an electric resistance value is thereby increased.

Next, a sealing process of dipping the corrosion-resistant material into boiling water for 30 minutes, namely, a boiling process is performed. As a result, the aluminum oxide coating film 6 of the substrate upper part 1a formed by anodization is hydrated, to thereby generate the hydrated aluminum oxide. When the hydrated aluminum oxide is generated (swelled) in the fine pore 4, the sealing part 3 of the hydrated aluminum oxide is formed as shown in FIG. 1, to thereby seal the fine pore 4 not from outside but from inside. The fine pore can be easily sealed up to an innermost part thereof, because the fine pore is sealed from inside.

The hydrated aluminum oxide and the corrosion-resistant metal or the corrosion-resistant alloy is stable to the electrolytes and potentials of sulfuric acid, oxalic acid, phosphoric acid, and chromic acid. Therefore, the corrosion-resistant property of the corrosion-resistant material can be ensured.

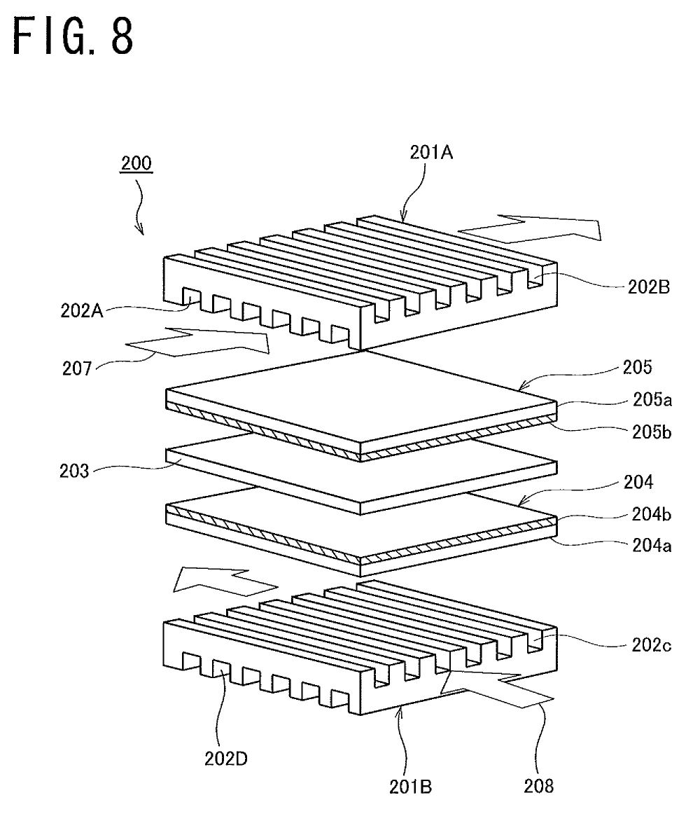

A separator for a fuel cell can be obtained by applying secondary working such as press working to the aforementioned corrosion-resistant material. FIG. 8 shows an outline structure of a solid polymer electrolyte fuel cell using such a separator for a fuel cell. A solid polymer electrolyte fuel cell 200 is constituted, with a plurality of cells connected vertically (in a vertical direction in the figure), with one cell having flat plate-shaped pair of separators 201A and 201B including grooves 202A, 202B, 202C, 202D formed on both surfaces at prescribed intervals; an electrolyte film 203 formed at an intermediate position of the separators 201A and 201B; an air electrode 204 disposed between the electrolyte film 203 and the separator 201B; and a fuel electrode 205 disposed between the electrolyte film 203 and the separator 201A.

The air electrode 204 and the fuel electrode 205 are electrically connected by the separators 201A and 201B which serve as members for preventing a fuel and air (oxidant) from mixing with each other. The grooves 202B and 202D are used as passages of the fuel and air in the vertically connected cells.

The electrolyte film 203 is constituted by using a polymer electrolyte film. The air electrode 204 includes a porous support layer 204a and an air electrode catalyst layer 204b, and the fuel electrode 205 includes a porous support layer 205a and a fuel electrode catalyst layer 205b.

In FIG. 8, when the air electrode 204 is brought into contact with air 208, and simultaneously the fuel electrode 205 is brought into contact with hydrogen gas 207 as a fuel, the hydrogen gas 207 is converted into hydrogen ions and electrons on the fuel electrode 205. The hydrogen ions move toward the air electrode 204, together with water in the electrolyte film 203. Meanwhile, the electrons move toward the air electrode 204 via an external circuit.

In the air electrode 204, reaction occurs among oxygen (O₂/2), electrons (2e⁻), and hydrogen ions (2H⁺) to thereby generate water (H₂O).

According to the separator for a fuel cell of this embodiment, it is possible to sufficiently respond to a request for the corrosion-resistant property against gas in a reducing atmosphere and an oxidizing atmosphere.

### EXAMPLES

First, as shown in FIG. 4, the coating layer 2 having 100 nm thickness was deposited by sputtering of Ti (titanium) on the surface of the substrate 1 made of aluminum (pure aluminum: 1051 (JIS)) having 1 mm thickness and 200 mm×150 mm size, to thereby form the corrosion-resistant material. Note that the size of the substrate 1 was determined from the size of a power generation surface of the fuel cell.

Next, as shown in FIG. 3, the corrosion-resistant material was disposed in the electrolyte layer liquid, and the surface of the substrate upper part 1a exposed under the fine pore 4 of the corrosion-resistant material was anodized by energization, to thereby form the aluminum oxide coating film 6. Thereafter, the aluminum oxide coating film 6 was boiled for 30 minutes as described above. Water used in boiling must be basically neutral. Hydration is considered to be completed in about 10 minutes of boiling. However, the boiling time was set to be 30 minutes for assurance. The inter-electrode distance between the anode and the cathode was set to be 5 cm, the current density during anodization was set to be 0.03 A/cm² in a steady state, the voltage for anodization was set to be 40V, and the liquid temperature of the electrolyte solution was set to be 50° C., respectively.

Note that the steady state means a state in which a large current instantaneously flows before the oxide film is formed, and thereafter almost constant current flows, to make the current stable.

As a result, the aluminum oxide coating film 6 is hydrated, to thereby generate the hydrated aluminum oxide, and as shown in FIG. 1, the fine pore 4 of the coating layer 2 can be sealed from the substrate upper part 1a, by the sealing part 3 of the hydrated aluminum oxide that swells in the generated fine pore 4 having about 100 nm diameter.

In the same way as the coating layer 2 made of titanium, the sealing part 3 of the hydrated aluminum is stable to the electrolytes and potentials of sulfuric acid, oxalic acid, phosphoric acid, and chromic acid, thus exhibiting a high corrosion-resistant property.

### Example 2

The corrosion-resistant material was formed by anodizing and boiling, in the same way as the example 1 excluding a point that the coating bath 2 made of titanium nitride was formed and pre-processing was performed prior to anodization.

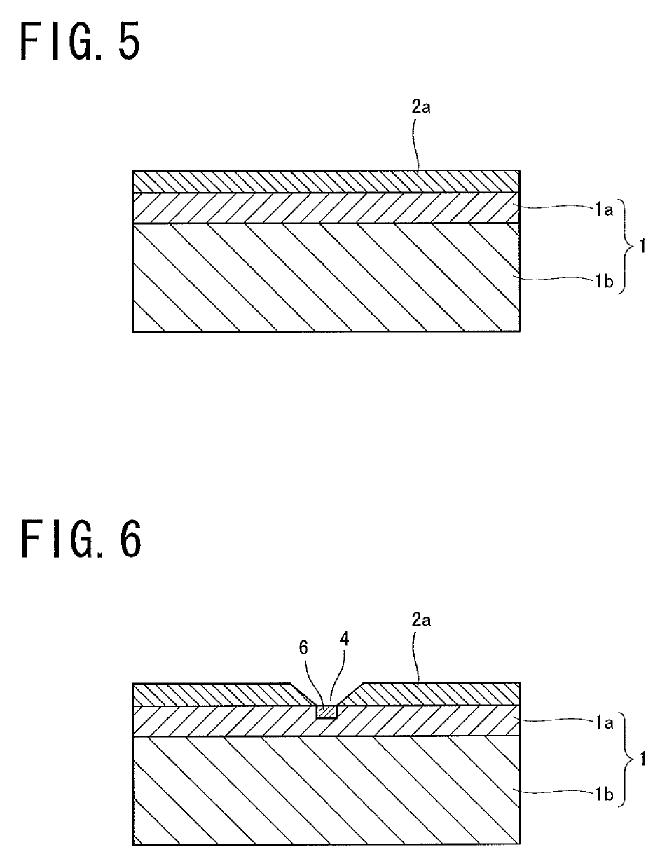

First, titanium nitride was used as the raw material of a corrosion-resistant metal, then a source gas of the titanium nitride was supplied by CVD, and as shown in FIG. 5, a coating layer 2a made of titanium nitride having 100 nm thickness was formed on the surface of the substrate upper part 1a. Aluminum (pure aluminum: 1051 (JIS)) having 1 mm thickness and 200 mm×150 mm size was used in the substrate 1, in the same way as the example 1.

After the coating layer 2a was formed on the surface of the substrate upper part 1a, as a corrosion-resistant layer, pre-processing of adding heat was performed in the atmospheric air or in an oxygen atmosphere as the pre-processing of anodization, and processing of preventing the elution of titanium during anodization was performed. As processing conditions, a temperature was set to be 300° C. and a time was set to be 10 minutes.

Subsequently, the substrate 1 that has undergone the processing was disposed in the electrolyte liquid, and anodization was performed by energizing. As a result, as shown in FIG. 6, oxidation of aluminum was advanced and the aluminum oxide coating film 6 was formed on the surface of the substrate upper part 1a exposed under the fine pore 4. Thereafter, in the same way as the example 1, the aluminum oxide coating film 6 was boiled for 30 minutes in the boiling water.

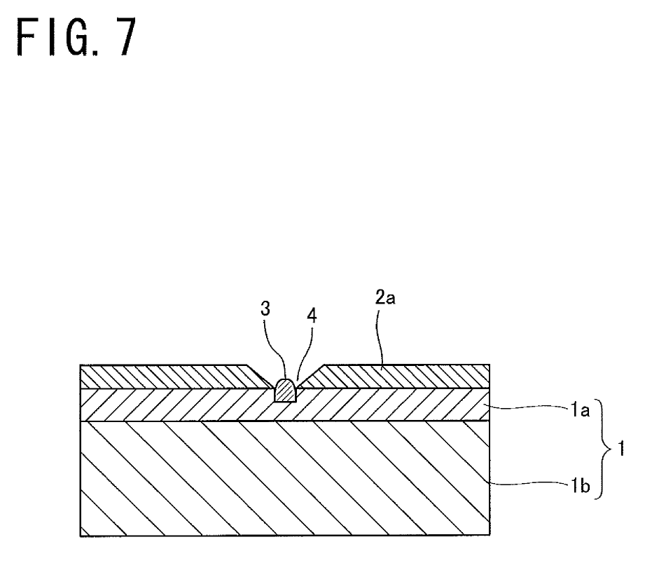

Thus, the aluminum oxide coating film 6 was hydrated to thereby generate the hydrated aluminum oxide, and as shown in FIG. 7, the fine pore 4 could be sealed from the substrate 1 side by the sealing part 3 of the hydrated aluminum oxide that swells in the fine pore 4.

In the same way as the coating layer 2a made of titanium, the sealing part 3 made of hydrated aluminum oxide was stable to the electrolytes and potentials of the sulfuric acid, oxalic acid, phosphoric acid, and chromic acid, etc, and a high corrosion-resistant property was exhibited.

### Example 3

In this example, a plurality of substrates 1 were prepared, and thin films made of stainless, nickel, chromium, gold, platinum, palladium, rhodium, copper, tin, and silver were deposited on the surface of each substrate 1 as other corrosion-resistant materials, and in the same way as examples 1 and 2, the anodizing process and the boiling process were respectively executed.

In any one of the corrosion-resistant metals, in the same way as the examples 1 and 2, the aluminum oxide coating film 6 was deposited on the surface of the substrate upper part 1a under the fine pore 4, to thereby seal the fine pore 4 of the coating layer 2 by the sealing part 3. Thus, the corrosion-resistant property of the corrosion-resistant material could be ensured.

The present invention can be executed in various modes, and therefore the scope of the present invention is not limited to the aforementioned embodiments and examples. The scope of the present invention is defined by claims, and all modifications within the scope of the claims and equivalence thereto is incorporated in the claims.

What is claimed is:

1. A corrosion-resistant material, comprising:
a substrate with at least one surface made of aluminum or an aluminum alloy;
a corrosion-resistant coating layer for coating the one surface of the substrate; and
a corrosion-resistant sealing material made of hydrated aluminum oxide, generated in fine pores, being a defect that occurs in the corrosion-resistant coating layer, to thereby seal the fine pores.

2. The corrosion-resistant material according to claim 1, wherein the corrosion-resistant coating layer is made of one kind selected from titanium, titanium nitride, stainless, nickel, chromium, gold, platinum, palladium, rhodium, copper, tin, and silver.

3. The corrosion-resistant material according to claim 1, wherein the corrosion-resistant coating layer is made of any one of a nitride of titanium and aluminum, an oxide of titanium and aluminum, and a mixture thereof.

4. A manufacturing method of a corrosion-resistant material, comprising the steps of:
forming a corrosion-resistant coating layer on at least one surface of a substrate made of aluminum or an aluminum alloy;
generating a corrosion-resistant sealing material made of hydrated aluminum oxide in fine pores, being a defect that occurs in the corrosion-resistant coating layer; and
sealing the fine pores by the sealing material.

5. The manufacturing method of the corrosion-resistant material according to claim 4, wherein the corrosion-resistant coating layer is made of one kind selected from titanium, titanium nitride, stainless, nickel, chromium, gold, platinum, palladium, rhodium, copper, tin, and silver.

6. The manufacturing method of the corrosion-resistant material according to claim 4, wherein the corrosion-resistant coating layer is made of any one of a nitride of titanium and aluminum, an oxide of titanium and aluminum, and a mixture thereof.

7. The manufacturing method of the corrosion-resistant material according to claim 4, wherein the step of generating the corrosion-resistant sealing material includes the step of oxidizing one surface of the substrate exposed in the fine pores, and the step of hydrating the one surface of the oxidized substrate.

8. The manufacturing method of the corrosion-resistant material according to claim 7, wherein the step of oxidizing is the step of anodizing.

9. The manufacturing method of the corrosion-resistant material according to claim 7, wherein the step of hydrating is the step of boiling.

10. A separator for a fuel cell, comprising:
a substrate with at least one surface made of aluminum or an aluminum alloy;
a corrosion-resistant coating layer for coating the one surface of the substrate; and
a corrosion-resistant sealing material made of hydrated aluminum oxide, generated in fine pores, being a defect that occurs in the corrosion-resistant coating layer, to thereby seal the fine pores.

11. A manufacturing method of a separator for a fuel cell, comprising the steps of:
forming a corrosion-resistant coating layer on at least one surface of a substrate made of aluminum or an aluminum alloy;
generating a corrosion-resistant sealing material made of hydrated aluminum oxide in fine pores, being a defect that occurs in the corrosion-resistant coating layer; and
sealing the fine pores by the sealing material.
